(19) United States
(12) Patent Application Publication
(10) Pub. No.: US 2007/0171301 A1
(43) Pub. Date: Jul. 26, 2007

(54) Image static area determination apparatus and interlace progressive image transform apparatus

(75) Inventor: Masahiro Tatsumi, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/413,191

(22) Filed: Apr. 28, 2006

(30) Foreign Application Priority Data
Jan. 20, 2006 (JP) 2006-013074

(51) Int. Cl. H04N 7/01

(52) U.S. Cl. 348/446

(57) ABSTRACT

A unit for generating a pseudo image of an earlier field image by interpolation from a later field image in two consecutive field images in an interlace scanning system, and a unit of determining a static area in the images upon receipt of the input of a current frame image, a previous frame image, an earlier field image, and a pseudo-field image are included. A motion which cannot be detected between frame images can be detected by comparing an earlier field image with apseudo-field image.

### CROSS REFERENCE TO RELATED APPLICATIONS

This application is based upon and claims the benefit of priority from the prior Japanese Patent Application No. 2006-013074, filed on Jan. 20, 2006, the entire contents of which are incorporated herein by reference.

### BACKGROUND OF THE INVENTION

1 Field of the Invention

The present invention relates to a system of processing, for example, a video image, and more specifically to, for example, an apparatus for determining a static area between consecutive frame images, and an image transform device for transforming a field image in an interlace scanning system to a frame image in a progressive scanning system by applying the determination apparatus.

2. Description of the Related Art

For example, in a video signal processing device, determining a static area between consecutive frames is an important technique for efficient signal processing. For example, in transforming a field image in the interlace scanning system to a frame image in the progressive scanning system, determining a static area is an important technique for preventing flicker and a blur.

The conventional technology in the static area determining system is explained below by referring to FIGS. 1 and 2. FIG. 1 is a block diagram of the configuration of the conventional technology of the image static area determination apparatus. In FIG. 1, the determination apparatus includes an pixel value difference extraction unit 100 for obtaining a difference of pixel values of pixels corresponding to each other between two frame images in response to the input of a previous frame image and the current frame image, a block leveling unit 101 for averaging in units of block the difference in pixel value of each pixel, and a block stillness determination unit 102 for determining stillness of a block using the output of the block leveling unit 101 and a predetermined determination threshold.

FIG. 2 is an explanatory view of a static area determining operation in units of block by the image static area determination apparatus shown in FIG. 1. The static area determining process is performed on a block constituted by 2×2 pixels enclosed by the central solid lines shown in FIG. 2 in the previous frame image and the current frame image. However, when the stillness of a block is determined in a 2×2 pixel block, the pixel value difference extraction unit 100 obtains the difference in pixel value of the corresponding pixels between the previous frame image and the current frame image on the 4×4 square area pixels (enclosed by the dotted line in FIG. 2) including each pixel surrounding the block, the block leveling unit 101 calculates the average value of 16 difference values, and the average value is provided for the block stillness determination unit 102 as an average value for the block constituted by 2×2 pixels. When the value is smaller than the determination threshold, the block is determined as a static area, and a determination result signal is output.

However, in the conventional system, since the difference in pixel value is obtained between directly corresponding pixels as explained by referring to FIG. 2, a very small motion not detected by the eyes of a person can indicate a difference between pixel values, thereby determining a block to be determined as a non-static area. For example, there is the problem that flicker occurs in a frame image in the progressive scanning system transformed from a field image in the interlace scanning system.

In one of the conventional technologies (for example, the patent document 1) relating to the method of detecting a static area in images, for example, the difference in pixel value between corresponding pixels in consecutive frames is calculated. Based on the calculated value, a reliable static area detecting algorithm for obtaining a final map of a static areas by deleting an isolated static area or adjacent small blocks of static areas on a provisional map of a static area generated by accumulating differences in pixel value in units of block is disclosed.

However, in the technology of the patent document 1, since the difference in pixel value is obtained only between the pixels in consecutive frames, the difference in pixel value caused by a slight motion of an image has an influence on determining a static area, a result of the image signal processing causes flicker and a blur.
[Patent Document 1] Japanese Patent Application Laid-open No. 2000-78533.

As described above, contrary to the problem that a very small motion not detected by naked eyes can be determined that a block to be determined is not a static area when a determination on a static area is made only by a difference in pixel value of the corresponding pixels between consecutive frame images, there is the problem that a motion to be detected that there is a motion between frame images cannot be detected. An example of an image causing such a problem is stripes. The problem that the motion of stripes moving on the screen cannot be detected is explained below by referring to FIGS. 3 through 7 while discriminating the field image in the interlace scanning system from the image (frame image) in the progressive scanning system as an image obtained by combining the field images.

FIG. 3 shows an example of output of a field image in the interlace scanning system with time. The field image in the interlace scanning system comprises a top field image constituted by scan lines of, for example, odd numbers in the scan lines in the horizontal direction on the screen, and a bottom field image constituted by scan lines of even numbers. The top and bottom field images are output, for example, every 1/60 second.

FIG. 4 shows an example of output of an image in the progressive scanning system. In the progressive scanning system, a frame image is generated and output by sequentially scanning from top to bottom without discriminating scan lines between odd numbers and even numbers. The frame image is basically constituted by combining the top field image with the bottom field image shown in FIG. 3.

FIG. 5 shows an example of stripes for explanation of a problem. The stripes obtained by repeating the areas of black, white, black, white, . . . in the horizontal direction as shown are supposed to move toward right in apart on the screen, for example, around the center of the screen.

FIG. 6 shows an example of an image in the interlace scanning system when the stripes moves toward right and an image in the progressive scanning system obtained by combining the images in the above-mentioned system. On the left side of FIG. 6, first, the top field image is output, and stripes (t=0) shown on the upper left appears at the central portion in the output image. Then, for example, after 1/60 second, a bottom field image is output. In the bottom field image, the stripes move right, and appear as shown at the second (t = 1/60) from the top on the left. The top and bottom field images are combined, and the progressive image shown at the upper right is output as a frame image.

Then, after 1/60 second more, the next top field image is output. On the image, the stripes are moved further right. Then, on the bottom field image output after 1/60 second, stripes are further moved, and a progressive image obtained by combining these two field images, that is, a frame image, is as shown at the lower portion on the right.

FIG. 7 shows a frame image corresponding to the progressive image shown in FIG. 6 shown by the pixel image as shown in FIG. 3. Each of the black and white rectangles in each field image or a progressive image in FIG. 6, for example, corresponds to two pixels in FIG. 7. The pixels corresponding to the top scan line and the bottom scan line other than the black or white pixels corresponding to stripes are expressed in all gray.

As described above, the stripes shown in FIG. 5 moving at a portion on the screen, for example, at the central portion should be indicated by the previous frame image and the current frame image shown in FIG. 7. However, when a static area is determined between two frame images with a block of 2×2 pixels at the central portion as shown in FIG. 2, the block is naturally determined as a static area, and it is not detected that the stripes moves right on the screen. The problem cannot be naturally solved by technology of the aforementioned patent document 1.

### SUMMARY OF THE INVENTION

The present invention has been developed to solve the above-mentioned problems, and aims at determining a static area between consecutive frame images by not only comparing consecutive frame images, but also comparing, for example, a earlier field image with a pseudo-field image obtained by interpolating the field image using a later field image, thereby making it possible to detect a motion that cannot be detected between frames as in the case of stripes, and obtaining an average value of pixel values including the adjacent pixels instead of obtaining a difference in pixel value using only the pixel values of corresponding pixels, and obtaining the difference between the average values. Thus, flicker and a blur as a result of image signal processing can be successfully reduced.

The image static area determination apparatus includes a pseudo-image generation unit and an intra-image static area determination unit. The pseudo-image generation unit obtains a pseudo-field image of a earlier field image by interpolation from a later field image between two consecutive field images in the interlace scanning system. The intra-image static area determination unit determines the static area in images upon receipt of the input of the current frame image, a previous frame image, an earlier field image, and a pseudo-field image.

According to the present invention, not only two consecutive frame images are compared, but also a pseudo-field image generated by interpolation from a later field image in the interlace scanning system is compared with an earlier field image. For example, it is possible to detect the motion not detected by comparing frame images such as the motion of stripes. Furthermore, by applying such a static area determining system to an interlace-progressive image transform, a frame image corresponding to a result of correctly detecting a motion can be generated.

### BRIEF DESCRIPTION OF THE DRAWINGS

FIG. 1 is a block diagram of the configuration of the conventional technology of the image static area determination apparatus;

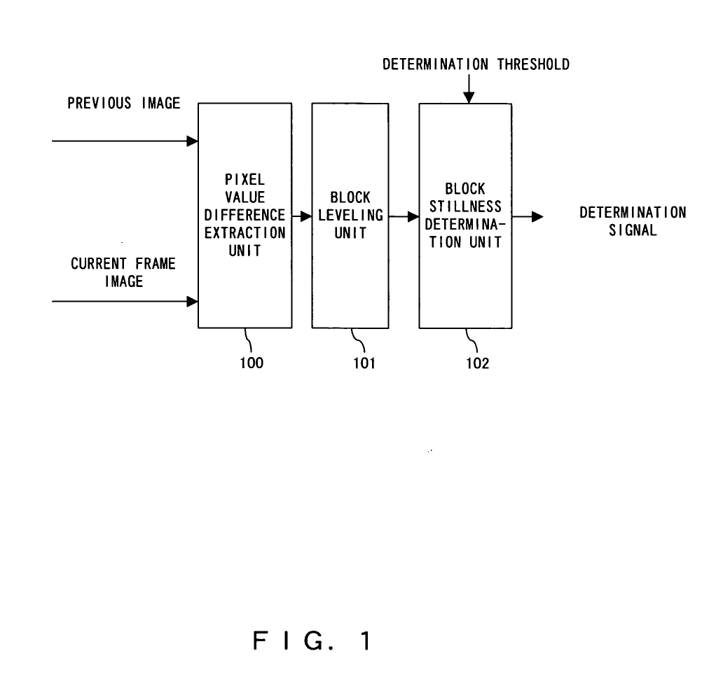

FIG. 2 is an explanatory view of a conventional technology of an image static area determining system

FIG. 3 is an explanatory view of an interlace image output system;

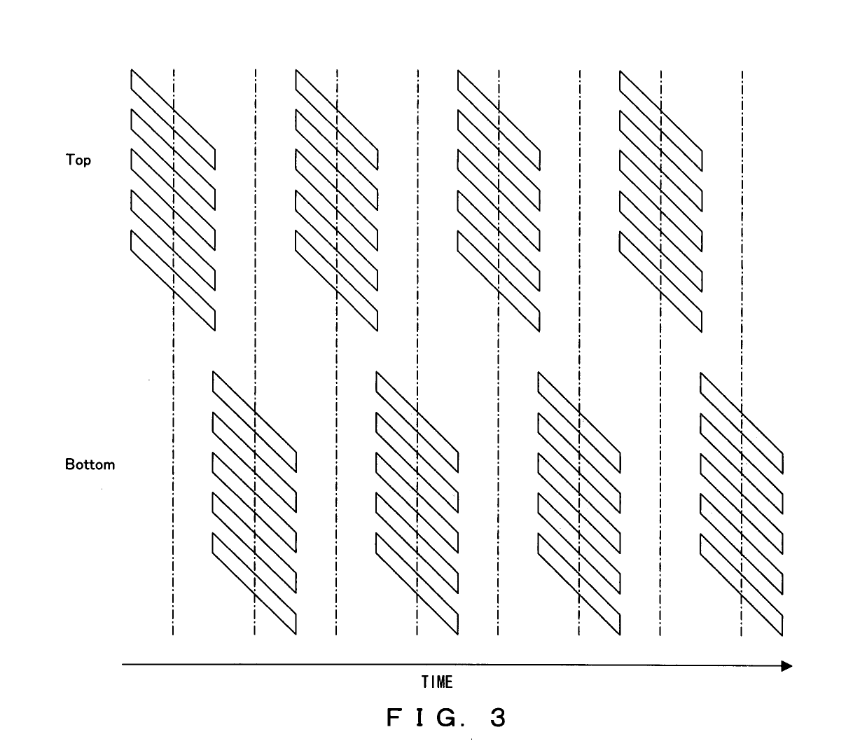

FIG. 4 is an explanatory view of a progressive image output system;

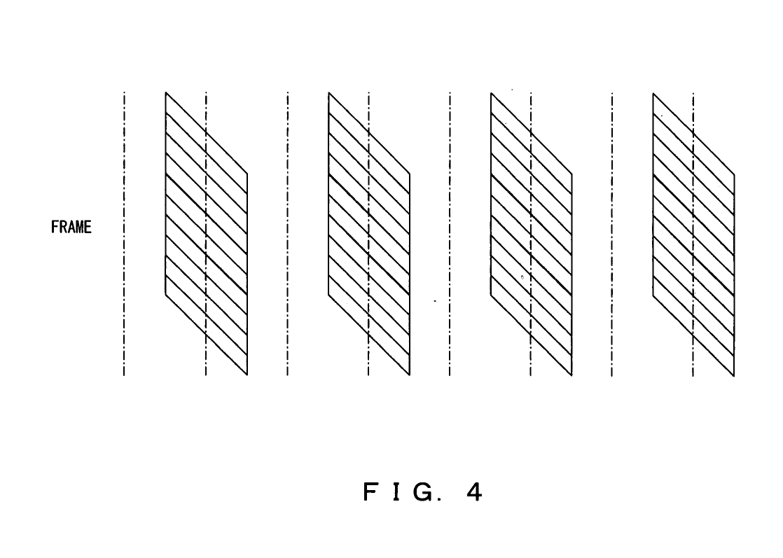

FIG. 5 is an explanatory view of stripes in an image;

FIG. 6 is an explanatory view of a progressive image when stripes move on the screen;

FIG. 7 is an explanatory view of a conventional technology of comparing the current frame image with the previous frame image;

FIG. 8 is a block diagram of the configuration showing the principle of the image static area determination apparatus according to the present invention;

FIG. 9 is a block diagram of the basic configuration of the interlace-progressive image transform apparatus using the image static area determining system according to the present invention;

FIG. 10 is a block diagram of the basic configuration of the area determination unit shown in FIG. 9;

FIG. 11 is a block diagram showing the configuration of the details of the static area determination unit and the moving picture area determination unit;

FIG. 12 shows an example (1) of pixel area handled in the block leveling process in a frame image;

FIG. 13 shows an example (2) of pixel area handled in the block leveling process in a frame image;

FIG. 14 shows an example (1) of a target area of the block leveling process in a field image;

FIG. 15 shows an example (2) of a target area of the block leveling process in a field image;

FIG. 16 is a block diagram of an example of the configuration of the adjacent pixel value leveling unit;

FIG. 17 is an operation time chart of the adjacent pixel value leveling unit shown in FIG. 16;

FIG. 18 is a flowchart of the intra-image static area determining operation shown in FIG. 11;

FIG. 19 shows an example of an interlace image for explanation of an embodiment of the present invention;

FIG. 20 shows an example of an image obtained by combining with pseudo-field image;

FIG. 21 is an explanatory view of comparing an earlier field image with a pseudo-field image; and

FIG. 22 is an explanatory view of comparing frame images in an embodiment of the present invention.

### DESCRIPTION OF THE PREFERRED EMBODIMENTS

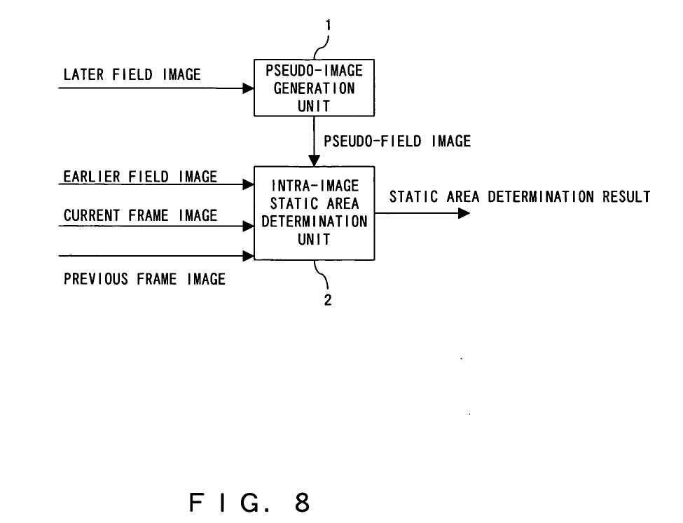

FIG. 8 is a block diagram of the configuration showing the principle of the image static area determination apparatus according to the present invention. In FIG. 8, the image static area determination apparatus includes a pseudo-image generation unit 1 and an intra-image static area determination unit 2.

The pseudo-image generation unit 1 obtains a pseudo-field image of an earlier field image by interpolation from a later field image in the two consecutive frame images in the interlace scanning system, and the intra-image static area determination unit 2 determines a static area in an image upon receipt of the input of a current frame image, a previous frame image, an earlier field image, and a pseudo-field image.

In the embodiment of the present invention, the intra-image static area determination unit 2 can also comprise a static area determination unit for determining a static area in the images upon receipt of the input of the current frame image and the previous frame image, and a moving picture area determination unit for determining a moving picture area which cannot be determined as such by the static area determination unit, using the above-mentioned earlier field image and the pseudo-field image, for the area determined as a static area by the static area determination unit.

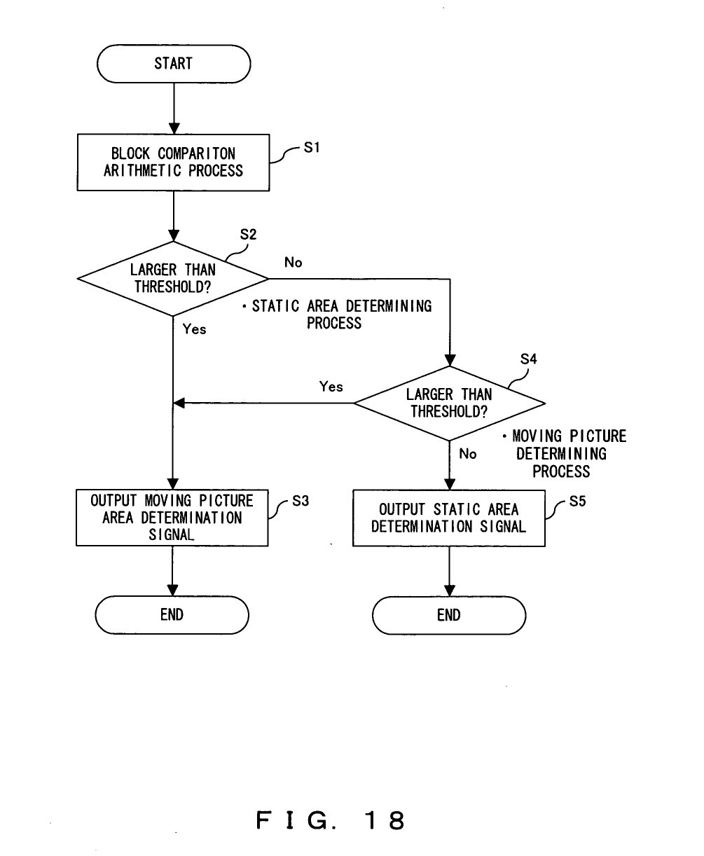

The interlace-progressive image transform apparatus according to the present invention comprises an image static area determination device whose principle is shown in FIG. 18, an image switch unit for outputting either the pseudo-field image output by the pseudo-image generation unit 1 or the earlier field image in response to the output of the intra-image static area determination unit 2, and a frame image output unit for combining the output of the image switch unit with the later field image and outputting the result as a frame image.

In an embodiment of the present invention, the image switch unit can output an earlier field image to an area determined as a static image by the intra-image static area determination unit 2, and a pseudo-field image to the area determined as a moving picture.

As described above, not only the current frame image is compared with the previous frame image, but also the pseudo-field image generated by interpolation from the later field image with the earlier field image, and the static area in the image can be determined.

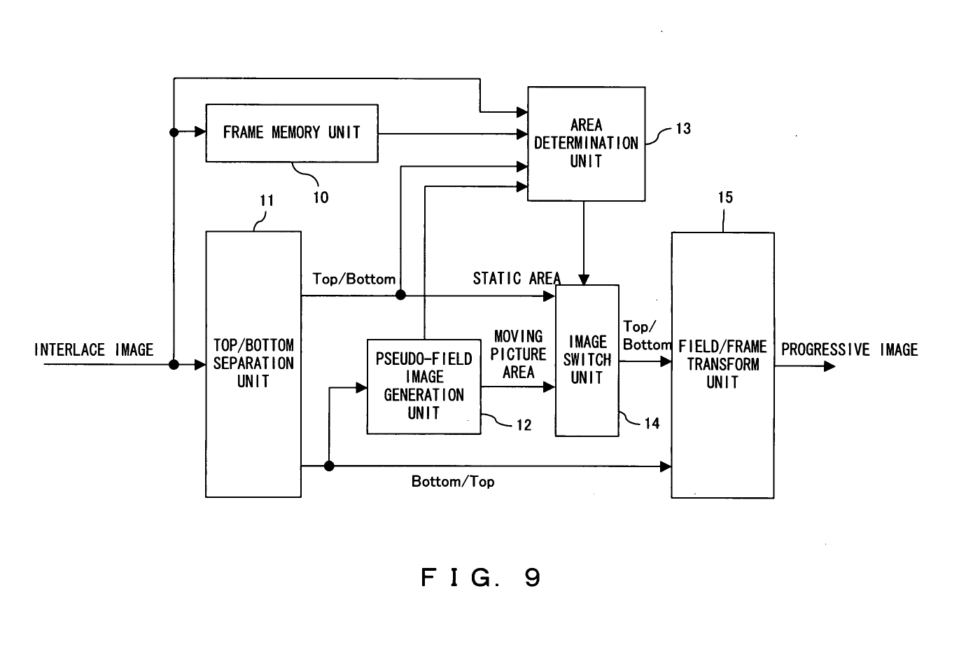

FIG. 9 is a block diagram of the basic configuration of the interlace-progressive image transform apparatus. The transform apparatus applies the static area determining system according to the present invention, and an area determination unit 13 determines the static area. The area determination unit 13 determines the static area in the images in response to the input of the current frame image, the previous frame image, the earlier field image, and a pseudo-field image generated by interpolation from the later field image, and outputs the result to an image switch unit 14.

In FIG. 9, a frame memory unit 10 holds the previous frame image. A top/bottom separation unit 11 separates a top field image from a bottom field image at the optional timing in response to the input of a field image in the interlace scanning system, outputs a earlier field image between the top field image and the bottom field image to the image switch unit 14, and outputs a later field image to a pseudo-field image generation unit 12 and a field/frame transform unit 15.

The pseudo-field image generation unit 12 generates a pseudo-field image corresponding to an earlier field image by the interpolating process from a later field image in the top field image or a bottom field image, and outputs the pseudo-field image to the area determination unit 13 and the image switch unit 14. Based on the determination result of the area determination unit 13, the image switch unit 14 selects either the earlier field image output from the top/bottom separation unit 11, that is, the top field image or the bottom field image, or the pseudo-field image output by the pseudo-field image generation unit 12, and outputs the selected field image, that is, the top field image or the bottom field image, to the field/frame transform unit 15. At this time, the output of the top/bottom separation unit 11 is selected for the area determined as a static area by the area determination unit 13, and the output of the pseudo-field image generation unit 12 is selected for the area determined not as a static area, that is, a moving picture area, and they are provided for the field/frame transform unit 15. The field/frame transform unit 15 combines the output of the image switch unit 14, that is, the earlier field image itself or its pseudo-field image, and the later field image as the output of the top/bottom separation unit 11, and outputs it as a progressive image, that is, a frame image.

The pseudo-image generation unit according to claim 1 of the scope of the claims for the patent of the present invention corresponds to the pseudo-field image generation unit 12, and the intra-image static area determination unit corresponds to the area determination unit 13. Furthermore, the image switch unit according to claim 9 corresponds to the image switch unit 14, and the frame image output unit corresponds to the field/frame transform unit 15.

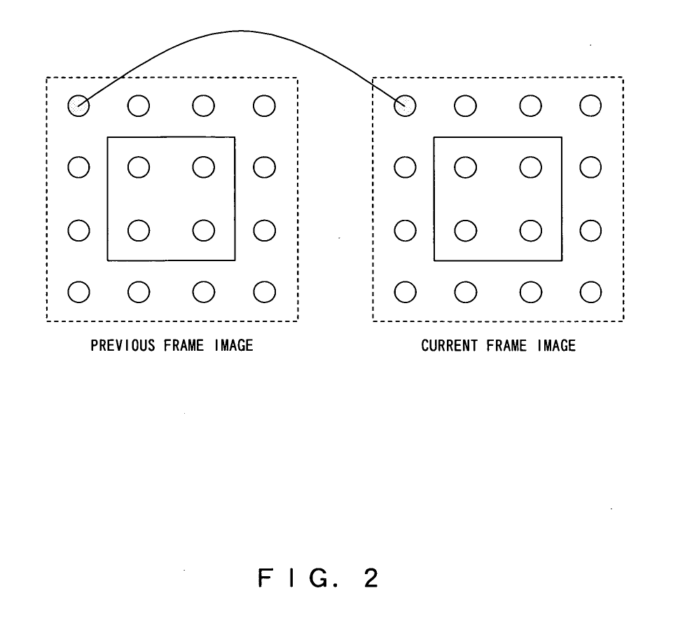

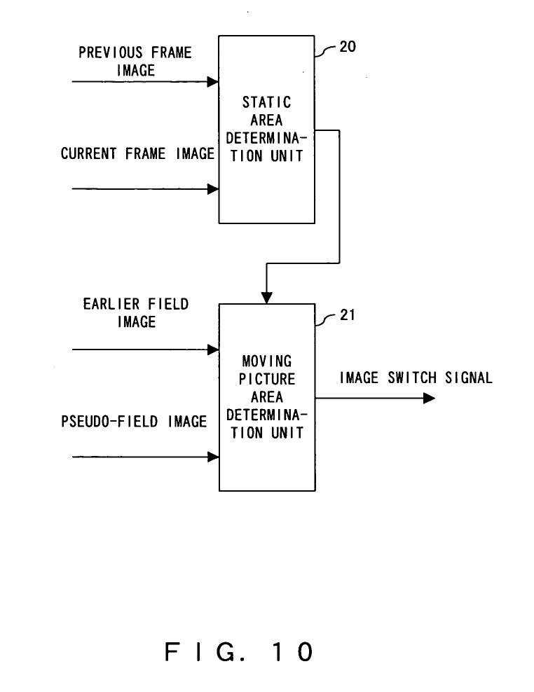

FIG. 10 is a block diagram of the basic configuration of the area determination unit 13 shown in FIG. 2. In FIG. 2, the area determination unit 13 is constituted by a static area determination unit 20 and a moving picture area determination unit 21. For the static area determination unit 20, the current frame image and the previous frame image are provided among the four inputs to the area determination unit 13 shown in FIG. 9. The static area determination unit 20 compares two frame images, performs a determination of a static image for an area in an image, for example, the block explained by referring to FIG. 2, and outputs the result to the moving picture area determination unit 21.

For an area determined as being static by the static area determination unit 20, for example, a block, the moving picture area determination unit 21 determines again whether the block indicates a static image or a moving picture. To the moving picture area determination unit 21, an earlier field image and a pseudo-field image generated by interpolation from a later field image, that is, a pseudo image corresponding to a earlier field image among the four inputs to the area determination unit 13 shown in FIG. 2, are input. It is determined whether or not an area to be determined, for example, whether or not a block is a moving picture area, is determined. According to the determination result, the final image switch signal is provided for the image switch unit 14.

As described later, the area determined as a non-static area by the static area determination unit 20, for example, a block, is not required to be determined again by the moving picture area determination unit 21, and an image switch signal can be immediately output to the image switch unit 14. According to the present embodiment, however, for a high-speed process for example, the moving picture area determination unit 21 operates concurrently with the static area determination unit 20, and the determination result of the moving picture area determination unit 21 is not used for the area determined by the static area determination unit 20 not as a static area, and an image switch signal is provided by the moving picture area determination unit 21 to the image switch unit 14.

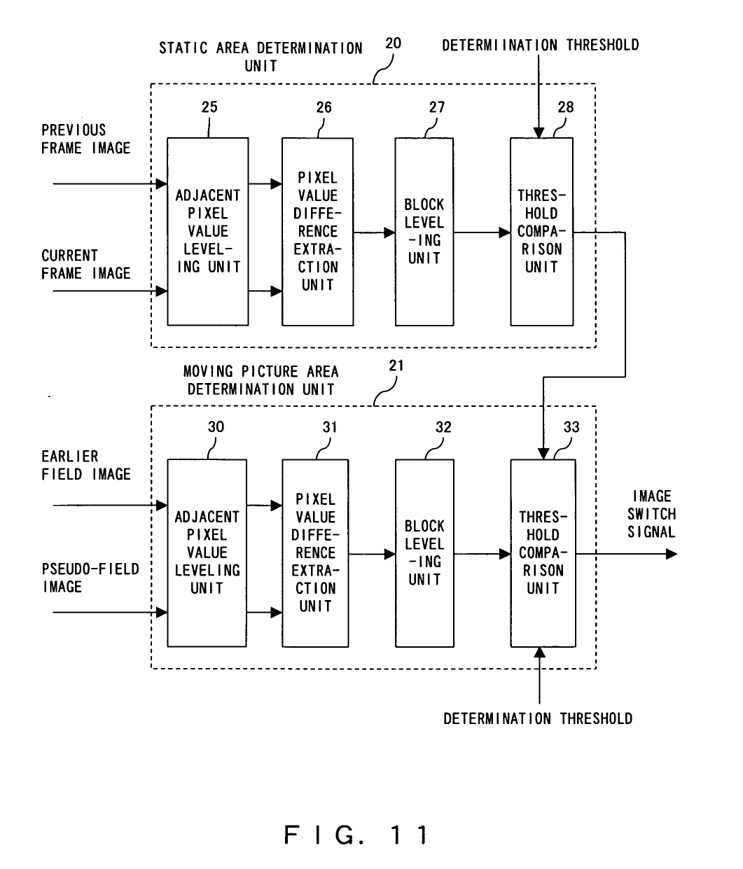

FIG. 11 is a block diagram of the detailed configuration of the static area determination unit 20 and the moving picture area determination unit 21 shown in FIG. 10. In FIG. 11 the static area determination unit 20 and the moving picture area determination unit 21 respectively comprises adjacent pixel value leveling units 25 and 30, pixel value difference extraction units 26 and 31, block leveling units 27 and 32, and threshold comparison units 28 and 33, each performing similar operations on input images. In the present embodiment, unlike the conventional system explained by referring to FIG. 2, for example, the adjacent pixel value leveling unit 25 obtains the average pixel values of the pixels adjacent to the target pixel including the target pixels, the pixel value difference extraction unit 26 compares the average values and obtains a difference value between frames. The details of the operation are furthermore described later.

The pixel value difference extraction unit 26 obtains a difference value between the pixels in the same positions in the two consecutive frame images using the leveled pixel value including the adjacent pixels. The block leveling unit 27 levels the difference values including the block comprising, for example, 2×2 pixels as explained by referring to FIG. 2, or furthermore the pixels around the block, and outputs the result to the threshold comparison unit 28. The threshold comparison unit 28 compares a predetermined determination threshold with the output of the block leveling unit 27, and outputs to the threshold comparison unit 33 in the moving picture area determination unit 21 a signal indicating that a block to be determined is not a static area when the output of the block leveling unit 27 is larger than the determination threshold. The operations of the adjacent pixel value leveling unit 30 in the moving picture area determination unit 21, the pixel value difference extraction unit 31, the block leveling unit 32, and the threshold comparison unit 33 are substantially the same as the operations of each block in the static area determination unit 20.

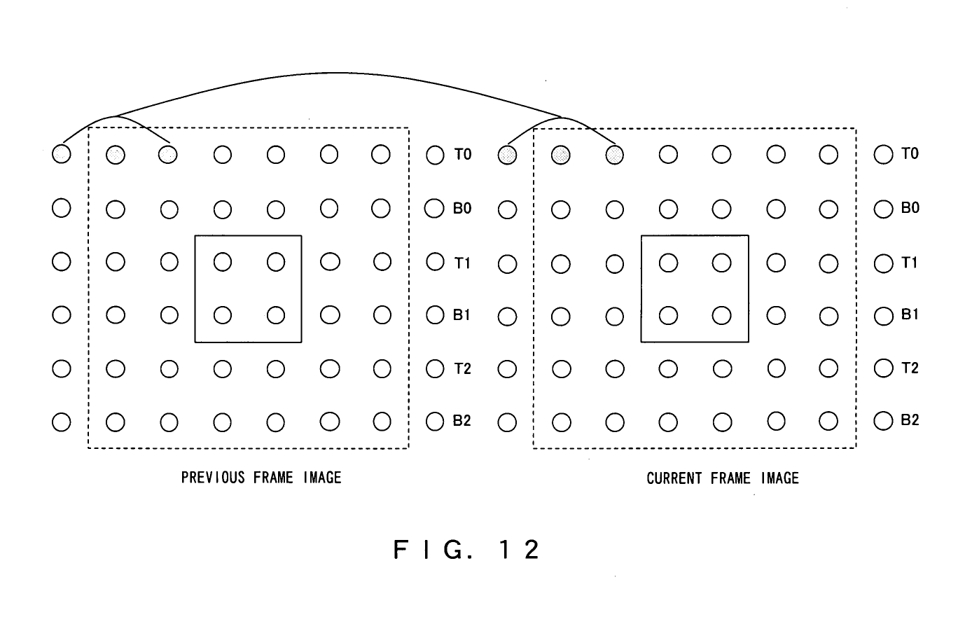

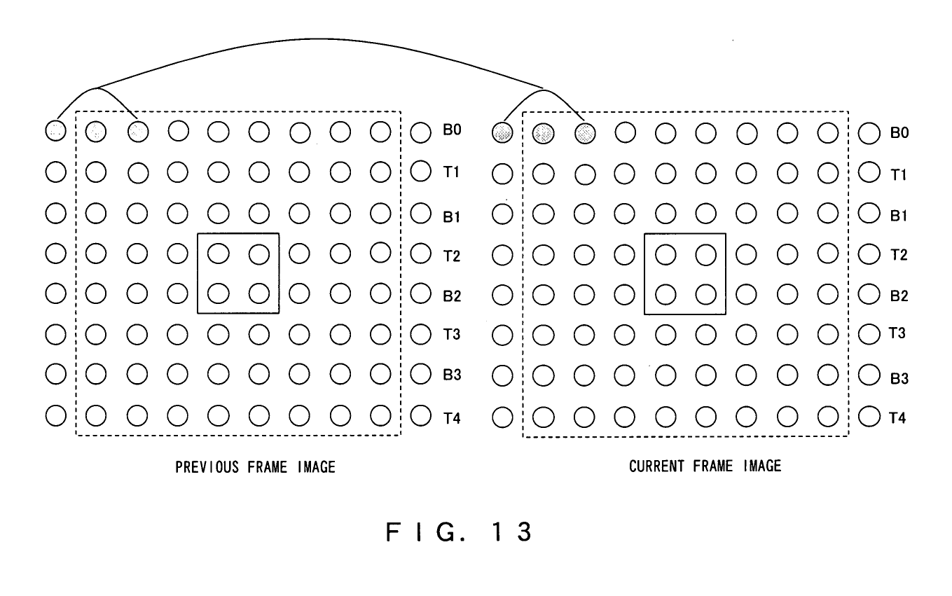

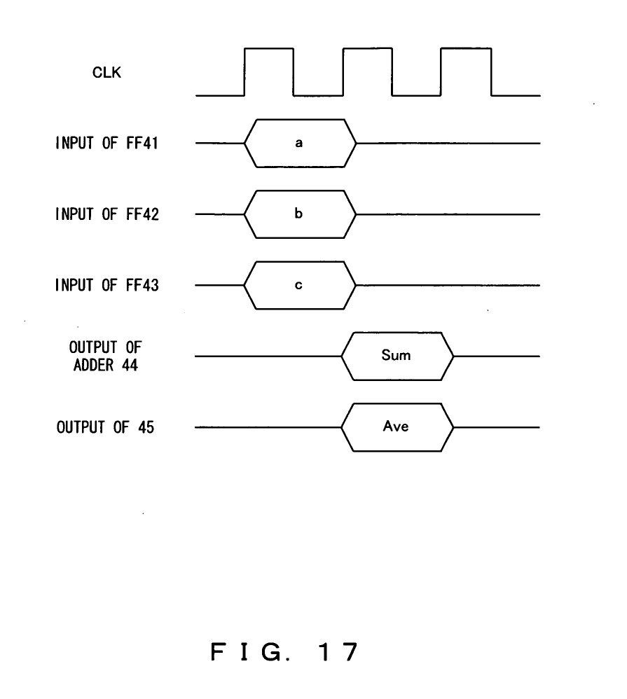

FIGS. 12 through 18 are further detailed explanatory views of the static area determination unit 20 and moving picture area determination unit 21 shown in FIG. 11. FIGS. 12 and 13 are explanatory views of an area of pixels in the block and the surround thereof to be leveled by the block leveling unit 27 in the static area determination unit 20 shown in FIG. 11. In FIG. 12, the block to be determined as a static area comprises the pixel of 2×2 around the center as in FIG. 17. However, in FIG. 12, unlike in FIG. 2, around the block, that is, the block indicated by the solid line frame, the area of dotted lines including two more pixels are to be leveled by the block leveling unit 27. That is, the target of difference value leveling by the block leveling unit 27 are pixels of 6×6 in the dotted line frame.

In FIG. 13, the target to be leveled by the block leveling unit 27 is further expanded, and can be the 8×8 pixels in the dotted line frame. Thus, as compared with the conventional technology shown in FIG. 17, the processing time is naturally prolonged by leveling pixels including a number of pixels around the block comprising 2×2 pixels to be determined as a static area, but it is empirically apparent that better determination result can be obtained for various types of pattern image.

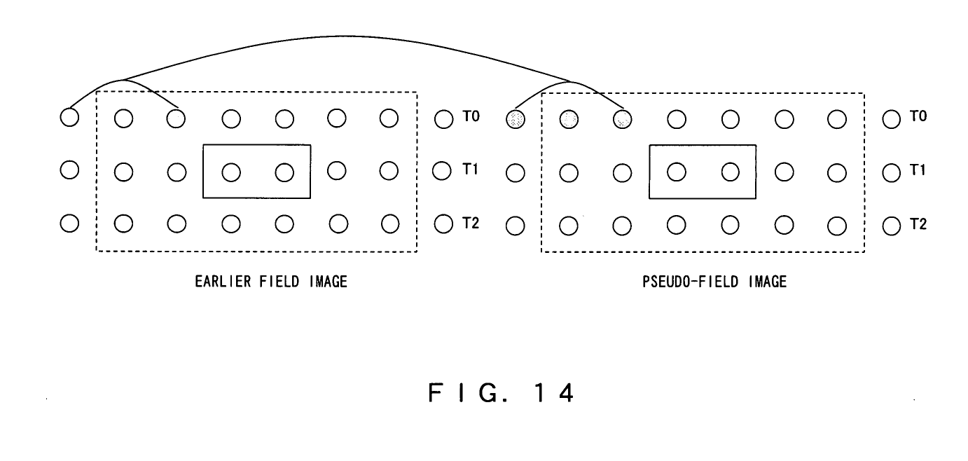

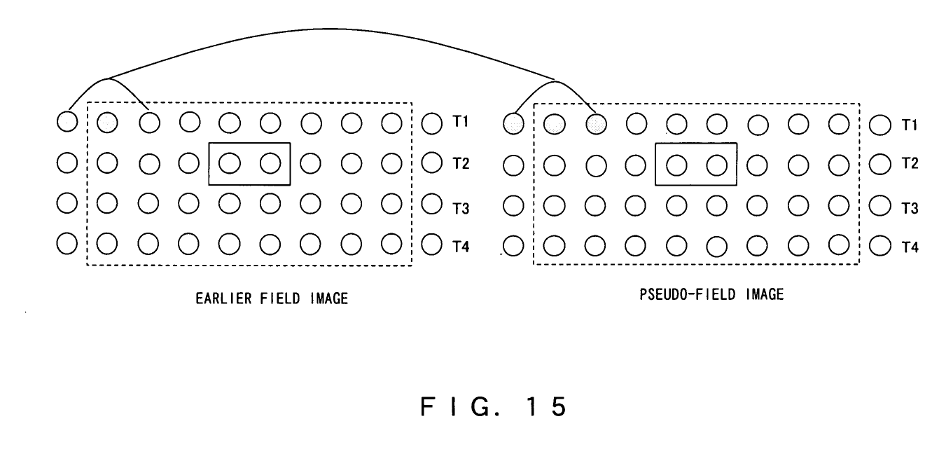

FIGS. 14 and 15 are explanatory views of pixel areas for which difference values are to be leveled by the block leveling unit 32 of the moving picture area determination unit 21 shown in FIG. 11. FIGS. 14 and 15 respectively correspond to the leveling target areas of the block leveling unit 27 shown in FIGS. 12 and 13.

In FIG. 14, a top field image as an earlier field image is compared with a pseudo-field image. That is, in the frame images, the pixels in the scan lines T0, T1, and T2 are to be leveled in a block. Furthermore, the block of the pixels to be determined as a static area is formed by 2×1 pixels around the center.

In FIG. 15, the pixels in the scan lines T1, T2, T3, and T4 corresponding to FIG. 13 are to be leveled by the block leveling unit 32, and the blocks to be determined as static areas are formed by the 2×1 pixel in the scan line T2.

In FIGS. 12 through 15, for each pixel to be leveled enclosed by the dotted lines, the average value of the pixel values including the adjacent left and right pixels is obtained by the adjacent pixel value leveling units 25 or 30, and the resultant average values are compared by the pixel value difference extraction units 26 and 31 and a difference value is extracted and provided for the block leveling unit 27 or 32. That is, in the leveling process performed by the adjacent pixel value leveling unit 25 or 30 the average value are obtained by the following equation.
average value ={X (i−1, j)+X(i, j)+X (i+1, j)}/4,
where i, j and X(i,j) mean the vertical coordinate, the horizontal coordinate of a pixel and the pixel value respectively.

The average value including the adjacent pixels is divided by 4, not 3, to facilitate the process by hardware. Next, the difference arithmetic performed by the pixel value difference extraction unit 26 or 31 is performed by the following equation as for the difference between the average pixel values obtained by the adjacent pixel value leveling unit 25 or 30, for example, as for the difference between the Xp (i, j) for the current frame image and the Xr (i, j) for the previous frame image.
difference value=Xp (i, j)−Xr (i, j).

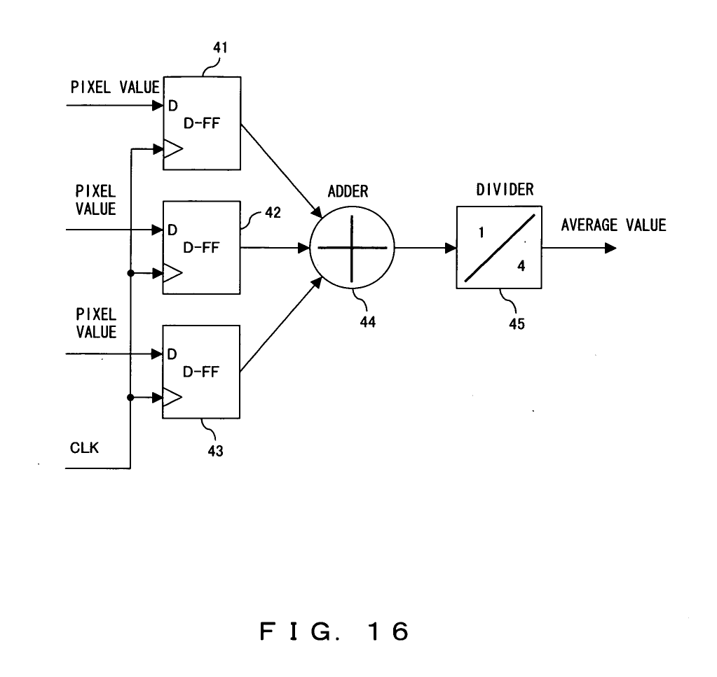

FIG. 16 is a block diagram of an example of the configuration of the adjacent pixel value leveling unit 25 or 30 shown in FIG. 11, and FIG. 17 is a time chart of the adjacent pixel value leveling operation. In FIG. 16, the adjacent pixel value leveling unit 25 or 30 comprises three data flip-flops (D-FF) 41, 42, and 43, an adder 44, and a divider 45.

In FIG. 17, at the first clock, the pixel values a, b, and c of the three pixels are input to each of the FF 41 through 43. At the next clock, an addition result Sum is output from the adder 44, and the divider 45 outputs a division result Ave as an average value.

In the present embodiment, as explained by referring to FIGS. 12 through 15, the average value of the three pixels including the left and right adjacent pixels is used as a pixel value of a target pixel, but the settings of the adjacent pixels are not limited to this application. For example, it is obviously possible to obtain an average value of nine pixel values including a total of eight pixels adjacent to the target pixels.

FIG. 18 is a flowchart of the static area determining operation by the static area determination unit 20 and the moving picture area determination unit 21 shown in FIG. 11. In FIG. 8, when operations are started, first in step S1, a block comparison arithmetic process is performed. This process corresponds to the process from the adjacent pixel value leveling unit 25 through the block leveling unit 27 in the static area determination unit 20, and to the process from the adjacent pixel value leveling unit 30 through the block leveling unit 32 in the moving picture area determination unit 21. It is also possible to perform the process from the adjacent pixel value leveling unit 30 up to the block leveling unit 32 after a determination signal from the threshold comparison unit 28 in the static area determination unit 20 is provided for the moving picture area determination unit 21. However, in the present embodiment, the block comparison arithmetic process by the static area determination unit 20 and the moving picture area determination unit 21 can be concurrently performed to perform the process at a high speed.

In step S2, the threshold comparison unit 28 in the static area determination unit 20 determines whether or not the output of the block leveling unit 27 is larger than the determination threshold. When it is larger, a moving picture area determination signal is immediately output as an image switch signal to the image switch unit 14 shown in FIG. 9 through the threshold comparison unit 33 in the moving picture area determination unit 21. From the image switch unit 14, a pseudo-field image generated by the pseudo-field image generation unit 12 is output to the field/frame transform unit 15.

When it is determined in step S2 that the output is not larger than the threshold, it is determined in step S4 whether or not the output of the block leveling unit 32 is larger than the determination threshold by the threshold comparison unit 33 in the moving picture area determination unit 21. If it is larger, the moving picture area determination signal is output to the image switch unit 14 in step S3 like as described above. When it is not larger than the threshold, the static area determination signal is output in step S5, and the image switch unit 14 outputs an earlier field image itself output from the top/bottom separation unit 11 to the field/frame transform unit 15.

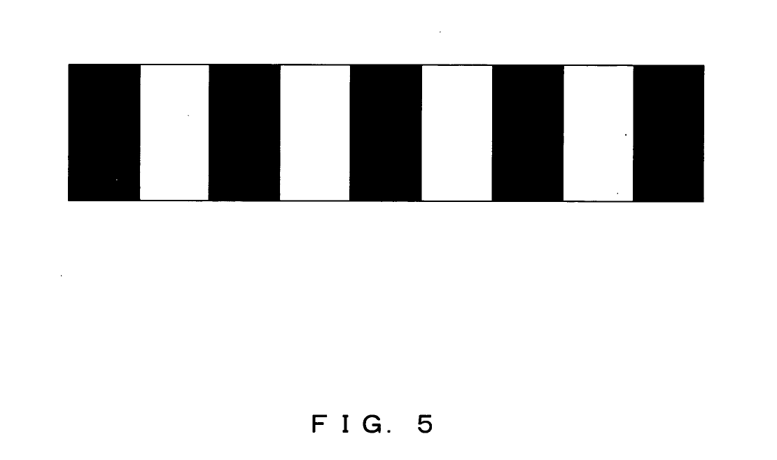

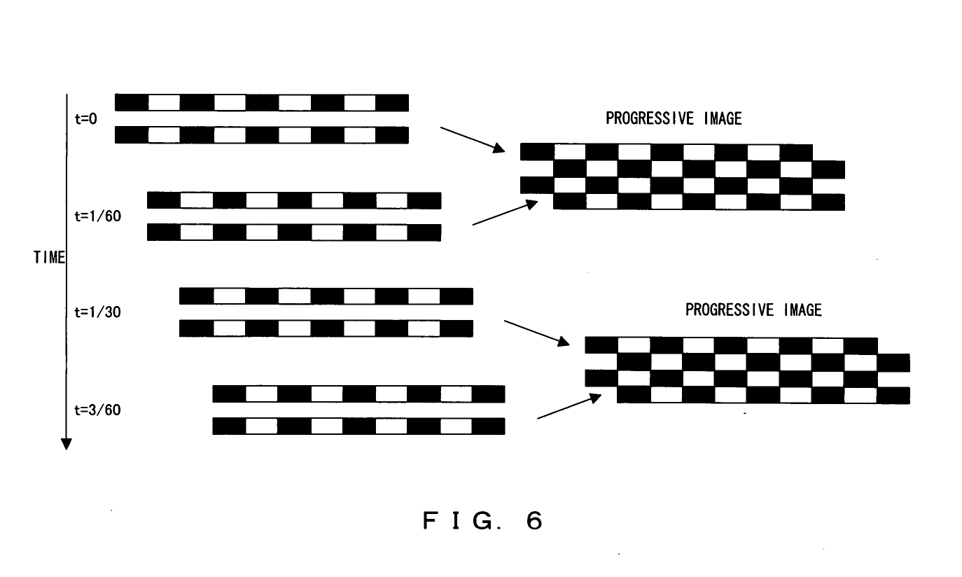

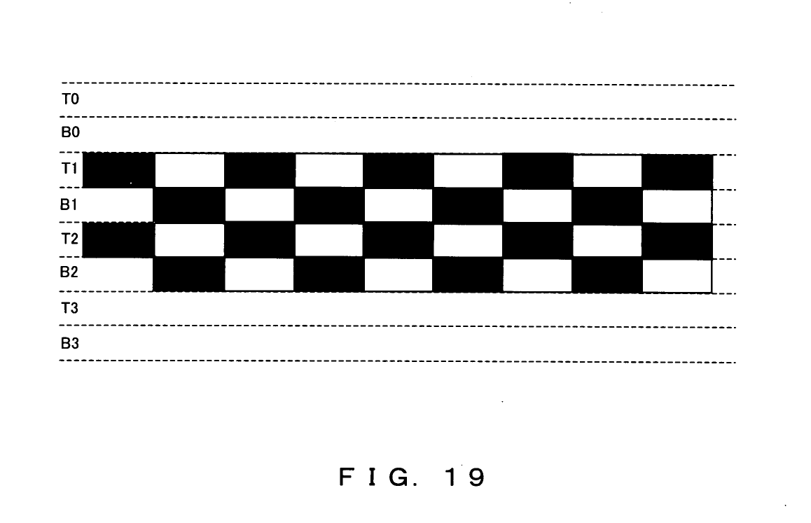

Finally, in the present embodiment, as explained by referring to FIGS. 5 through 7 of the conventional technology, a pseudo-field image when a stripe image moves as explained by referring to FIGS. 5 through 7, and an image to be determined by the moving picture area determination unit 21 using the pseudo-field image are explained below by referring to FIGS. 9 through 22. FIG. 12 shows an example of an interlace image. The image corresponds to the progressive image on the right shown in FIG. 6, the earlier field image is a top image, and the top field image is assumed to be constituted by the scan lines T0 through T3. A later field image, that is, a bottom image, is constituted by the scan lines B0 through B3, and the stripes are assumed to move along the scan lines T1, T2 in the top field image, and the scan lines B1 and B2 in the bottom field image.

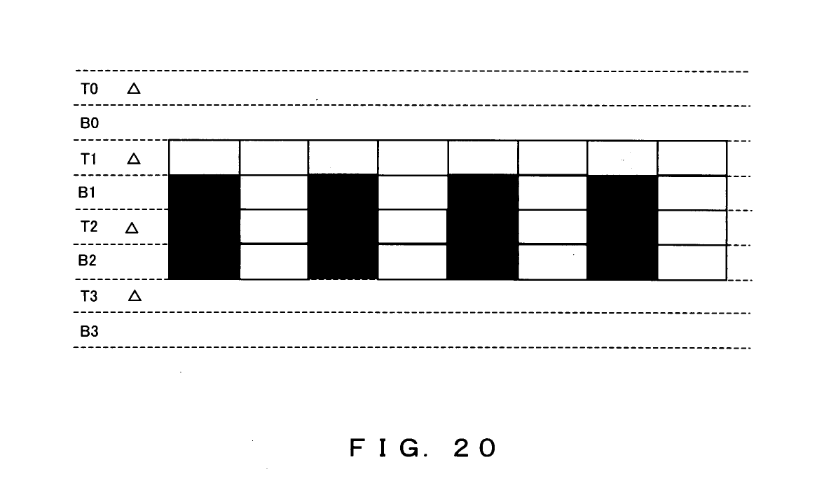

FIG. 20 shows an image as a result of obtaining a pseudo-field image corresponding to the top image as an earlier field image by interpolation from a later bottom field image, and combining the resultant pseudo-field image with a bottom image. Each of the scan lines T0 through T3 of the top field image forms a pseudo-field image. For example, the portion of the leftmost scan line T1 is changed from black to white as a result of the interpolating process using the scan lines B0 and B1 in the later bottom images. In this case, the interpolating process can be with various systems, but the simplest system can perform interpolation by leveling the pixel values of the up and down scan lines B0 and B1. Similarly, the portion of the scan line T2 is changed from black to white. Since the second portion from the left of the scan line T1 is not black in the position of the scan line B0 above, it is gray, and the portion of the scan line T2 is changed to black.

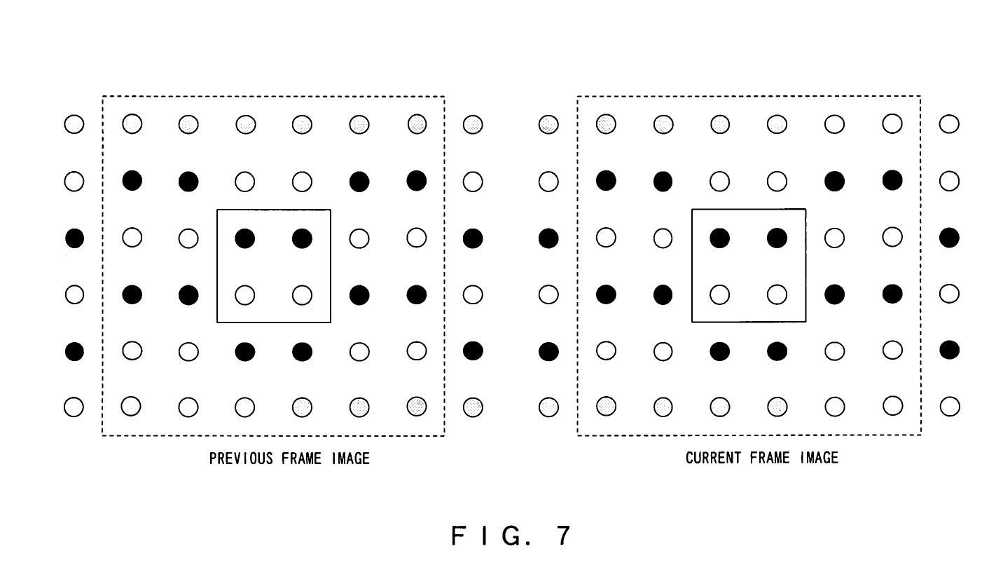

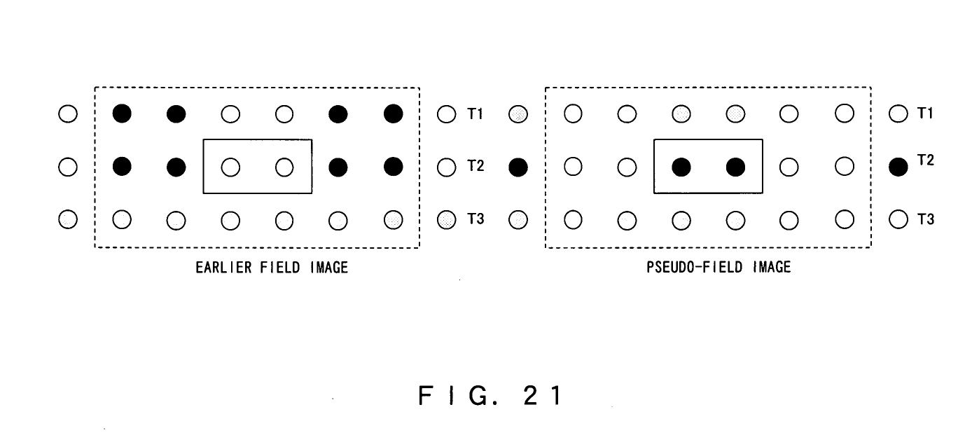

As in the conventional technology shown in FIG. 7, FIG. 21 is an explanatory view of comparing an earlier-field image among the pixel images, that is, the original top field image with a pseudo-field image generated by interpolation using a later bottom field image. The earlier field image on the left corresponds to the top field shown in FIG. 9. When the white pixels arranged in a horizontal line in the scan line T2 are assumed to be a block as a stillness determination target, for example, the pixel of the scan line T1 above the block is white, and the pixels in the lower scan line T3 is expressed as gray pixels not white nor black.

On the other hand, in the pseudo-field image on the right, the pixels in the scan line T2 in the block to be determined turn to black corresponding to FIG. 20, and the pixels in the scan line T1 above change to gray. The pixels in the scan line T3 remain gray. Thus, the comparison result between the earlier field image and the pseudo-field image apparently indicates moving pictures.

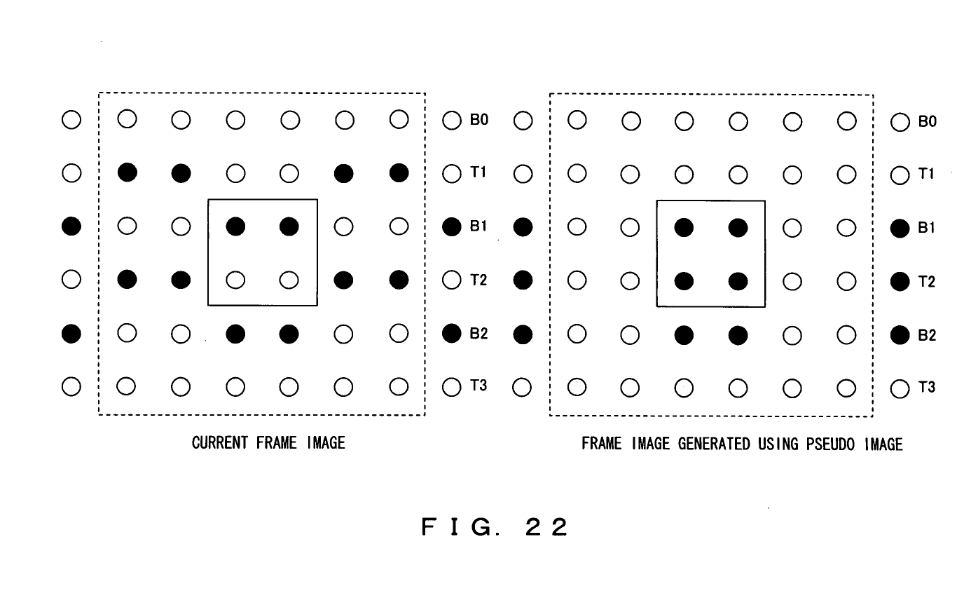

FIG. 22 is an explanatory view of the comparison between the frame image generated using a pseudo-field image and the current frame image. The left image corresponds to the frame image in FIG. 7, and the right image corresponds to the image shown in FIG. 20. In the present embodiment, as explained by referring to FIG. 9, the pseudo image input to the area determination unit 13 is a pseudo-field image generated by the pseudo-field image generation unit 12, and the frame image generated using a pseudo-field image is not used in determining an area, but a frame image generated using a pseudo image, that is, the right image shown in FIG. 15 is compared with the previous frame image shown in FIG. 7, thereby obviously detecting the motion between frame images.

What is claimed is:

1. An image static area determination apparatus, comprising:
a pseudo-image generation unit obtaining a pseudo-field image replaceable with an earlier field image by interpolation from a later field image in two consecutive field images in an interlace scanning system; and
an intra-image static area determination unit determining a static area in response to input of a current frame image, a previous frame image, an earlier field image, and a pseudo-field image.

2. The apparatus according to claim 1, wherein:
the intra-image static area determination unit comprises:
a static area determination unit determining a hypothetic static area in response to input of a current frame image and a previous frame image; and
a moving image area determination unit determining a moving image area in the hypothetic static area by comparing to input of the earlier field image and the pseudo-field image and determining the static area.

3. The apparatus according to claim 2, wherein the static area determination unit comprises:
an adjacent pixel value leveling unit obtaining an average value of pixel values of adjacent and identical pixels to a pixel for each pixel in inputted two frame images;
a pixel value difference extraction unit obtaining a difference between the average values of pixels in same positions in the two frame images; and
a threshold determining unit comparing the output of the pixel value difference extraction unit with a given determination threshold, and determining a static area in two frame images.

4. The apparatus according to claim 3, wherein the static area determination unit further comprises:
a block leveling unit leveling values of the differences in pixels in a block constituted by n×n pixels in a square area in same positions in two frame images using the output of the pixel value difference extraction unit; and
the threshold determination unit compares the output of the block leveling unit with the threshold, and determines a static area for the block.

5. The apparatus according to claim 4, wherein
the block leveling unit levels the values of differences for each pixel by adding adjacent pixels around the block to a pixel in a block constituted by n×n pixels in the square area.

6. The apparatus according to claim 2, wherein
the moving image area determination unit comprises:
an adjacent pixel value leveling unit obtaining an average value of pixel values of adjacent and identical pixels to a pixel for each pixel in inputted two field images;
a pixel value difference extraction unit obtaining a difference between the average values of pixels in same positions in the two field images; and
a threshold determining unit comparing the output of the pixel value difference extraction unit with a given determination threshold, and determining a moving area in two field images.

7. The apparatus according to claim 6, wherein:
the moving image area determination unit further comprises a block leveling unit leveling the values of the differences for each pixel in a block constituted by pixels included in two input field images among pixels corresponding to n×n pixels in a square area in an image generated by combining the earlier field image with a later field image using the output of the pixel value difference extraction unit; and
the threshold determination unit compares the output of the block leveling unit with the threshold, and determines a moving image area for the block.

8. The apparatus according to claim 7, wherein
the block leveling unit levels the values of the differences for pixels included in two input field images among the pixels corresponding to pixels obtained by adding pixels adjacent to the square area to n×n pixels in the square area.

9. An interlace-progressive image transform apparatus, comprising:
the image static area determination apparatus according to claim 1;
an image switch unit outputting either a pseudo-field image output by the pseudo-image generation unit or an earlier field image in response to the output of the intra-image static area determination unit; and
a frame image output unit combining the output of the image switch unit with the later field image, and outputting a result as a frame image.

10. The apparatus according to claim 9, wherein
the image switch unit outputs the earlier field image for an area determined as a static image by the intra-image static area determination unit, and the pseudo-field image for an area determined as a moving image.
